(19) United States
(12) Patent Application Publication
(10) Pub. No.: US 2011/0047786 A1
(43) Pub. Date: Mar. 3, 2011

(54) Guide plate for a system for securing a rail on a substrate and a system comprising such guide plate

(75) Inventors: Winfried Bösterling, Neuenrade (DE); Lutz Rademacher, Ludenscheid (DE); Farhad Esfandiyari, Iserlohn (DE); Michael Steidl, Chicago, IL (US)

(73) Assignee: Vossloh-Werke GmbH, Werdohl (DE)

(21) Appl. No.: 12/377,959

(22) PCT Filed: Feb. 11, 2009
(86) PCT No.: PCT/EP09/51588

§ 371 Date: Oct. 26, 2009

(51) Int. Cl. B23P 19/00

(52) U.S. Cl. 29/700

(57) ABSTRACT

A guide plate for securing a rail on a substrate, at which a shoulder is provided at the side of the rail path has an underside facing the substrate and an upper side, lying freely in the installation position and facing away from the underside, on which a spring element is supported. With such a component it is possible to build a rail securing arrangement with a system, in which the forces are dispersed by a shoulder present at or in the solid substrate, whereby a cut-out is formed into the underside, the dimensions of which are adapted to the shoulder such that, in the installation position, the shoulder engages freely into the cut-out, and in that a reinforcement rib is formed at a roof surface opposite an opening of the cut-out, which projects in the direction of the opening over a height which is less than the cut-out.

### CROSS-REFERENCE TO RELATED APPLICATIONS

This application is a National Phase Application of International Application No. PCT/EP2009/051588, filed on Feb. 11, 2009. The disclosure of the above application is incorporated herein by reference in its entirety.

### FIELD OF THE INVENTION

The invention relates to a guide plate for a system for securing a rail on a substrate, at which a shoulder is provided at the side of the rail path, which absorbs the forces arising when a rail vehicle travels over the rail. The guide plate in this situation has an underside facing the substrate and an upper side, lying freely in the installation position and facing away from the underside, on which a spring element can be supported, which is provided for the applying of spring elastic hold-down forces onto the rail which is to be secured.

The invention further relates to a system for securing a rail on a substrate, at which a shoulder is provided at the side of the rail path. The system according to the invention comprises in this situation a spring element for exerting an elastic hold-down force onto the rail, a guide plate for guiding the spring element, and a tensioning element for tensioning the spring element against the substrate.

The object of the guide plates with such systems consists on the one hand of absorbing the forces directed transverse to the longitudinal direction of the rail arising when the rail is traveled over, and transferring them onto the shoulder which is anchored securely to the substrate. On the other hand, the guide plates also serve as a mount for a spring element in each case, which, in the finished mounted state of a rail securing system equipped with the guide plate, exerts the required elastic hold-down force onto the rail foot.

### BACKGROUND

Guide plates known by the designation of “angle guide plates”, such as are offered by the Applicant, for example, under the designation “W14”, have a basic shape which in a plan view is rectangular and longitudinally extended, a guide surface being formed on the one longitudinal side facing the rail. This guide surface, in the fully mounted state of the guide plate, is in full contact on the rail foot, and fixes the position of the rail in the transverse direction. In this situation, the known angle guide plate has a passage aperture aligned approximately centrally, extending from its upper side to its underside, through which a securing bolt can be introduced during installation, which tensions the guide plate and the spring element allocated to it against the substrate.

In addition to the prior art explained heretofore, a guide plate is described in DE 41 01 198 C1 which is intended to secure a rail by means of a W-shaped tension clamp. Indentations are provided in the known guide plate, in which, after installation, the U-shaped curved middle part of the tension clamp comes to lie. In addition to this, the known angle guide plate has a groove, which in the installation position extends parallel to the rail. After installation, the sections of the tension clamp leading outwards are supported in this groove longitudinally and transversely to the rail which is to be secured in each case.

A precondition for the known guide plates described heretofore is that a shoulder is formed in or at the individual substrate, on which the guide plate is supported in the installed state. This shoulder is usually formed by a step formed at the substrate, against which the guide plate is supported in the installed state with its side facing away from the rail.

Another possibility for supporting a rail is described in U.S. Pat. No. 4,313,563. With this system for securing rails, also known by the designation “Safelok”, a shoulder piece manufactured from a cast iron material is cast into a solid substrate, formed as a rule from a concrete sleeper. This shoulder piece has a mounting in its section located freely on the surface of the solid substrate, the opening of which is arranged on the side of the step facing away from the rail which is to be secured.

With the Safelok system, a clip formed as a single piece from flat steel engages into the cut-out in the shoulder with a transverse piece, from which two spring-loaded arms emerge running essentially parallel to one another. These spring-loaded arms, seen in a side view, are guided, starting from the transverse piece located in the cut-out of the shoulder piece, in a large curve in the direction of the rail which is to be secured, wherein the spring-loaded arms in the non-tensioned state end in a position arranged beneath the transverse piece. In the installed state, the spring-loaded arms, appropriately pre-tensioned, press with their free ends onto the foot of the rail which is to be secured, the upper side of which is located at essentially the same height as the cut-out in the shoulder.

The advantage of the Safelok system lies in the fact that it can be installed with a specially shaped tool. It has been shown in practice that, as a consequence of the high loads imposed by heavy or high-speed traffic, load displacement and spring deflection losses occur within a short period of operation with the spring bars employed in these systems, as a result of which the spring force is substantially reduced. It may also occur that the spring bar becomes so severely deformed during installation that it loses the spring properties required for the rail to be held down in the proper manner. As a consequence of the slackening in the spring effect, the resistance to the rail foot being pushed through is also reduced in a direction aligned transverse to the longitudinal extension of the rail.

A further disadvantage of the known Safelok system which makes its negative effect particularly noticeable with heavy and high-speed traffic is that the rail with this system is not supported against tilting, which may arise in particular when high transverse forces occur. Finally, with the known Safelok system, the requirement for the greatest possible insulation of the rail in relation to the substrate supporting it can only be fulfilled with considerable effort and expenditure.

### SUMMARY OF THE INVENTION

In general, an aspect of the present invention is to provide a component with which it becomes possible to meet the demands of modern rail travel operation, also with such rail securing systems in which the dispersal of the forces occurring in travel operation takes place via a shoulder present at or in the solid substrate.

The component to be produced in accordance with an embodiment of the invention should be particularly suitable for converting in a simple way existing securing systems of the Safelok type so that they will reliably withstand the loads occurring in practice over a sufficiently long service life.

Likewise, a system for securing a rail should be provided in which the disadvantages referred to heretofore will no longer exist.

A guide plate according to the invention for a system for securing a rail to a substrate, at which a shoulder is present, at the side of the rail path, which absorbs the forces arising when a rail vehicle travels over the rail, has an underside facing the substrate and an upper side, lying freely in the installation position and facing away from the underside. In this situation, a spring element can be supported on the upper side of the guide plate, which is provided to apply spring elastic hold-down forces onto the rail which is to be secured.

According to the invention, a cut-out is now formed into the underside of the guide plate, the dimensions of which are adapted to the dimensions of the shoulder in such a way that, in the installation position of the guide plate, the shoulder engages freely into the cut-out.

In addition, at least one reinforcement rib is formed at the roof surface of the cut-out, opposite the opening of the cut-out; this reinforcement rib projecting in the direction of the opening of the cut-out by a height which is less than the height of the cut-out.

As a result of the cut-out formed from its underside into the guide plate according to the invention, the guide plate can be placed onto the shoulder present on the solid substrate in each case. The shoulder is in this case accommodated by the cut-out in such a way that the guide plate itself is supported on the solid substrate by its standing surface remaining on the underside.

If appropriate, in this situation there may be one or more intermediate layers present between the underside of the guide plate and the solid substrate, in order, for example, to achieve a defined flexibility and specific wear behaviour of the securing point formed by the guide plate and the components interacting with it, the “spring element” and “tensioning element”.

The at least one reinforcement rib according to the invention present in the mounting on its roof surface is dimensioned as standard in such a way that, with optimum conditions when fitted but still free of forces, there is a certain distance interval between its underside facing the shoulder and the surface of the shoulder facing it in each case. If the spring element located on the guide plate is tensioned, the guide plate may be deformed, until the rib is located on the shoulder and the roof section of the guide plate covering the cut-out and carrying the spring element is supported on the shoulder. This reliably prevents excessive bending of the guide plate.

In the event that, in the course of the tensioning of the spring element, there is a break in the reinforcement rib, this will not interfere with its support function, since in this case the guide plate is supported on the shoulder by means of the fragments remaining between the shoulder and the roof surface of the guide plate.

Because a break in the reinforcement ribs present in each case is deliberately taken into account, the reinforcement ribs are as a rule designed to be so narrow that they can only accommodate low transverse forces. Accordingly, the thickness of the reinforcement ribs is typically less than a fifteenth part, and in particular less than a twentieth part, of the width of the guide plate measured in the longitudinal direction of the rail which is to be secured. Accordingly, in practice the ribs are about 5 mm wide, while the guide plate is about 115 mm wide, measured in the longitudinal direction of the rail.

If the shoulder is not optimally positioned, due for example to its projecting too high above the substrate, or is seated too low or misaligned, a break in the reinforcement rib during installation will even be specifically induced. In this way, the free volume present in the mounting is automatically adapted to the requirement resulting as a consequence of the respective alignment and positioning of the shoulder, without the need for the installation procedure to be interrupted. Even if the shoulder is imprecisely positioned, the situation is reached where the guide plate is reliably supported on the shoulder present in or on the solid substrate.

In this way, guide plates according to an embodiment of the invention make it possible, with a particularly easy design, for the spring elements located on them to be subjected to preliminary tension with high forces without thereby the risk arising of the guide plate breaking. In this situation, a guide plate designed according to the invention is particularly suitable for converting existing securing systems, in which a corresponding shoulder is already present in or on the solid substrate. By the invention making use of this shoulder to support the guide plate according to the invention and a guide plate according to the invention being designed in each case in such a way that its cut-out automatically matches the shape and position of the shoulder concerned, the conversion can be carried out with extremely low effort and correspondingly minimized costs.

Two or more reinforcement ribs dimensioned in the manner according to the invention can be present in the cut-out of a guide plate according to the invention, if this will, for example, increase the security of the support and bracing of the roof section of the spring element covering the cut-out and, in the installed state, carrying the spring element.

A system according to an embodiment of the invention for securing a rail on a substrate, at which a shoulder is present at the side of the rail path, comprises a spring element for exerting an elastic hold-down force onto the rail, a guide plate for guiding the spring element, and a tensioning element for tensioning the spring element against the substrate. The advantages of the design of a guide plate according to the invention, summarized in a general manner heretofore, can be put to advantage with such a system in that its guide plate is designed in the manner according to the invention.

According to one embodiment of the invention, the guide plate has, on its face side, facing the rail which is to be secured, a flat contact surface for the rail foot. The support of the rail against the transverse forces arising when it is traveled over is effected by way of this contact surface.

Advantageously, the minimum of one reinforcement rib present in the mounting of a guide plate according to an embodiment of the invention is aligned transverse to the contact surface of the guide plate. In this way, the reinforcement rib not only supports the roof section of the guide plate, covering the mounting and carrying the spring element on its upper side, but also braces the guide plate in a direction aligned transverse to the longitudinal extension of the rail which is to be installed. Accordingly, despite the comparably large volume of the cut-out intended to accommodate the shoulder, the guide plate is in a position to accommodate high transverse forces reliably in the installation position.

An optimum support of the guide plate with simultaneous good protection of the shoulder can be achieved in that the cut-out formed in its underside is delimited on its front side facing the rail and its rear side opposite the front side, as well as the sides extending between the front and rear side in each case from a wall of the guide plate. This complete delimitation of the cut-out by walls of the guide plate has a positive effect if the shoulder is manufactured from a material subject to the risk of corrosion, such as cast iron or steel. In this embodiment of the invention such shoulders are protected by the guide plate against contact with corrosive media. In the event that, despite this, water or other fluids collect in the area of the cut-out may be conducted away through channels in the rear wall facing the rear side of the cut-out or into the side walls of the cut-out which lead to the outside, for carrying away fluid which might collect in the cut-out of the guide plate. The channels can in this situation be formed in a simple manner, in that they are open in the direction of the underside of the guide plate.

In particular, in application situations in which the shoulder present in or on the solid substrate is suitable for connection to tensioning means required for the tensioning of the individual spring element, as is the case, for example, with shoulders of the Safelok system cast as shoulder pieces into the solid substrate, it may be advantageous if a passage aperture is formed into the guide plate leading from its upper side into the cut-out, through which the tensioning element can be inserted which is required in each case for tensioning the spring element during installation. In order to compensate for the weakening of the roof section of the guide plate caused by this opening, it is possible for a reinforcement rib dimensioned in the manner according to the invention to be arranged in each case inside the cut-out on two opposing sides of the passage aperture. This arrangement of the reinforcement ribs provided according to the invention allows the material thicknesses to be reduced to a minimum in the area of the roof section of the guide plate despite the passage aperture formed there.

Due to the bracing and support of the guide plate achieved by the ribs according to the invention, it is easily possible for the guide plate to be manufactured as one piece from a plastic material. Manufacture from plastic not only has the advantage of particularly low weight and easy manufacture, but also offers good electrical insulation without additional measures being necessary. Minimal wall thicknesses with simultaneously optimized loading capacity are then achieved if the plastic is fiber-reinforced.

The material thickness can be further minimized, in particular in the area of the roof section covering the cut-out and in the installation position carrying the spring element, in that at least one reinforcement rib is also formed on the free upper side of the spring element. The explanations provided heretofore regarding the reinforcement ribs provided in the cut-out of the guide plate apply accordingly in respect of their advantageous positioning and design.

In addition, there may also be present on the upper side of the guide plate according to the invention, in a known manner, shape elements such as webs, indentations, ribs, and the like, for the lateral guidance section by section of the spring element to be supported on the guide plate.

One particularly advantageous embodiment of the invention for applications which require a high degree of electrical insulation for the rail consists of the guide plate carrying an insulator element on its face side facing the rail which is to be secured, extending parallel to the face side, which is intended, during installation, to be mounted on the foot of the rail which is to be secured, in such a way that the spring element applying the hold-down force takes effect on the rail by way of the insulator element. By the insulator element being firmly connected to the guide plate, its installation is extremely simple and can be particularly reliably accomplished with the aid of automatic installation machines. The secure connection between the guide plate and the insulator element can in this situation be produced in such a way that the insulator element is already connected to the guide plate as one unit at the time of manufacture, adhesively bonded to the guide plate or plugged onto it. In this situation, it is also possible, due to the fact that the transition area between the insulator element and the guide plate is designed as a predetermined break point, for it to be ensured in a simple manner that, due to the arrangement of the insulator element according to the invention, the hold-down force exerted onto the rail in the installation position will not be impaired. Accordingly, the insulator element will break off from the guide plate in a specific manner if a particular loading value is exceeded during the tensioning of the spring element. The insulator element is then freely movable and can simply follow the movements of the rail and the spring element.

The shoulder present in or on the respective solid substrate can be used in the manner according to an embodiment of the invention not only to support the guide plate itself, but can also be used as an abutment for the tensioning element used for tensioning the spring element. To achieve this, the tensioning element concerned may have a coupling section for positive-fit coupling to the shoulder provided at the substrate. By means of this coupling section the tensioning element engages, for example, into a corresponding mounting of the shoulder or interacts with a suitably shaped projection of the shoulder.

In order to guarantee a defined flexibility of the securing point formed by the securing system according to an embodiment of the invention, the system according to the invention can comprise an elastic intermediate layer, on which the rail stands when the system is installed in the finished state. This intermediate layer can be designed in such a way that, with the system installed in the finished state, it extends under the rail which is to be secured, in order to guarantee a defined flexibility for the rail.

To protect against excessive abrasive wear, it may be advantageous, in particular in areas in which there is high exposure to blown dust or sand, if the system according to an embodiment of the invention comprises an abrasion plate which, with the finish installed system, lies on the substrate. All the other elements of the system according to the embodiment of the invention then stand on this abrasion plate, which consists, for example, of a highly abrasion-resistant material.

The solid substrate on which the guide plate according to an embodiment of the invention and system according to an embodiment of the invention are mounted is typically formed by a concrete plate or a sleeper which is cast from concrete or a comparably solid load-bearing material. The sleeper can likewise be made of wood, plastic, or steel.

The shoulder on which the guide plate designed according to an embodiment the invention is supported can be formed as a shoulder piece with the Safelok system, which sits with a securing section securely in the substrate, while a shoulder section projects freely above the surface of the fixed substrate.

In the event of a guide plate being allocated to each longitudinal side of the rail, the installation and retention of the guide plate can be designed in a particularly simple and secure manner, in that the guide plates are connected to one another as one piece by a section which in the installation position extends under the rail.

Finally, the system can also comprise a plate resting on the substrate, at which the shoulder is formed and on which, in the finished installed state, the guide plate sits. Such plates, also designated in technical terms as “rib plates”, are in many cases used to simplify installation and to obtain uniform distribution of the forces arising when the individual securing point is traveled across.

### BRIEF DESCRIPTION OF THE DRAWINGS

The invention is described in greater detail hereinafter on the basis of drawings representing an embodiment. These show in diagrammatic form:

FIG. 1 A guide plate in a perspective view from below;

FIG. 2 The guide plate in a perspective view from above;

FIG. 3 A rail securing system in a plan view;

FIG. 4 The rail securing system in a sectional view along the section line A-A shown in FIG. 3;

FIG. 5 A tensioning element used in the rail securing system, in a perspective view;

FIG. 6 The guide plate according to FIG. 1 in a view from below.

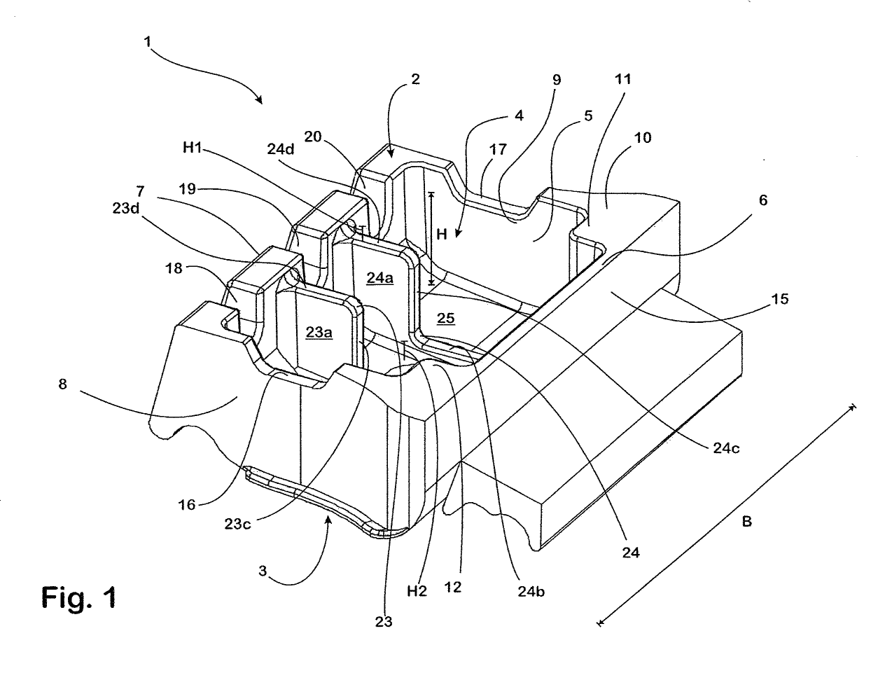

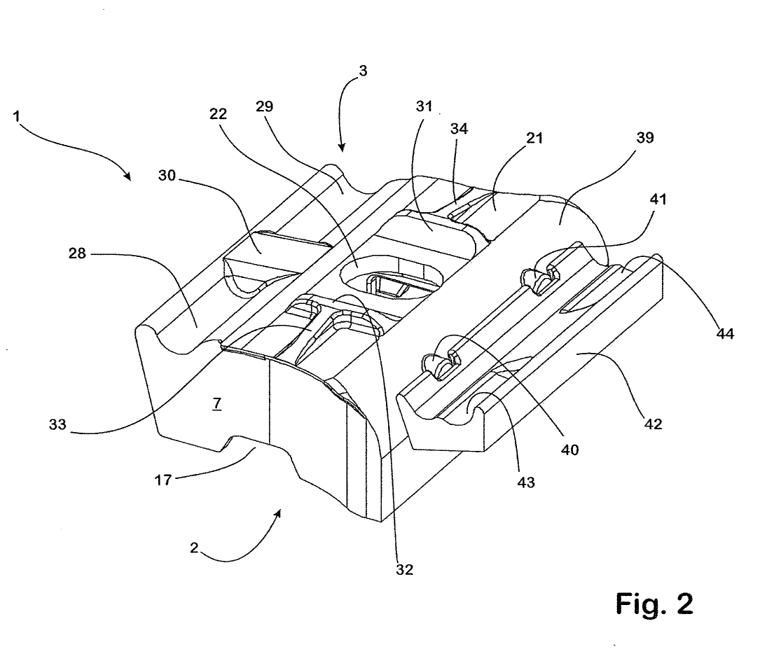

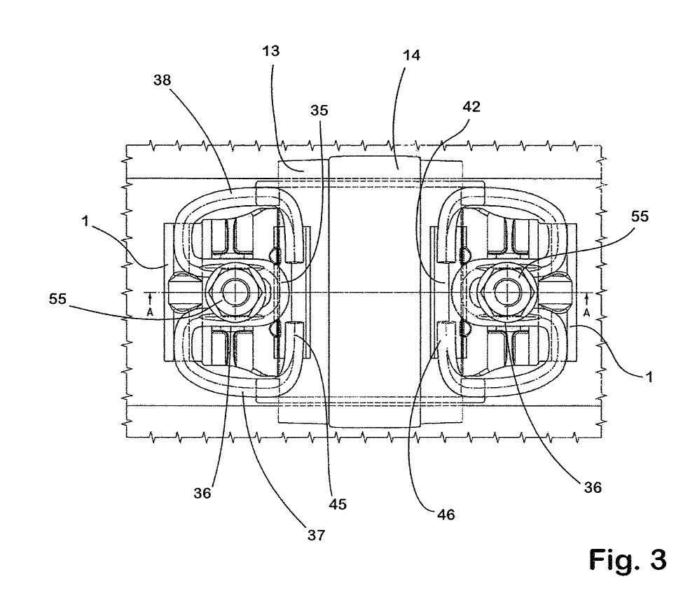

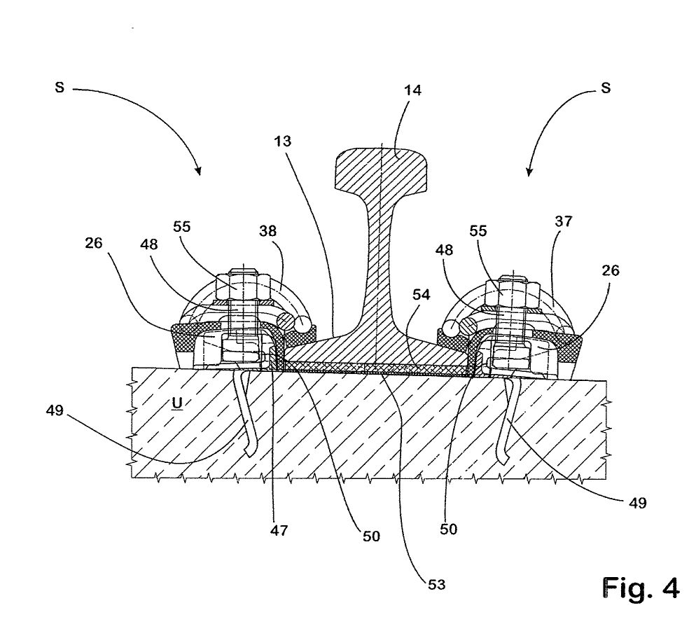

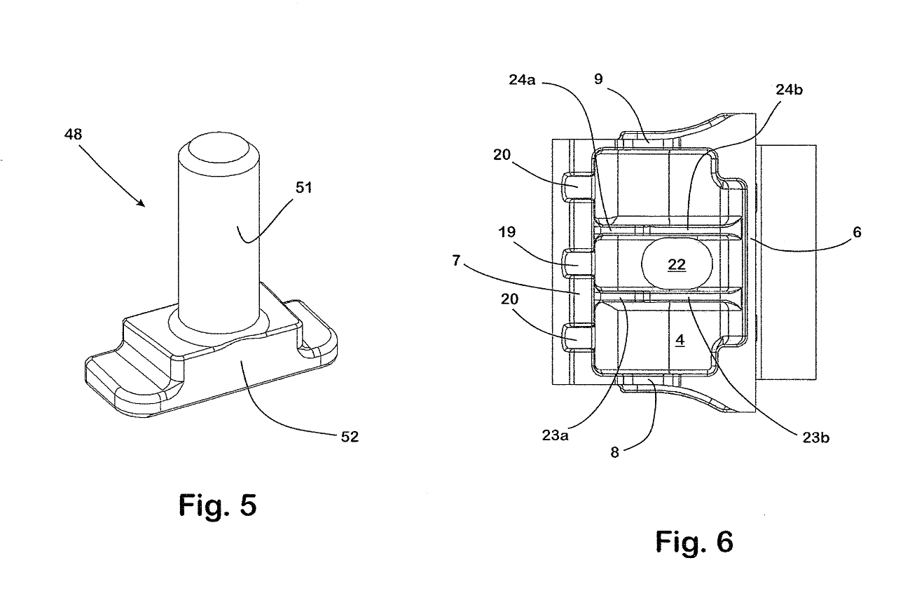

### DETAILED DESCRIPTION

The guide plate 1, manufactured from fiber-reinforced plastic as a single piece and having the basic shape of a rectangular parallelepiped, has an underside 2 and an upper side 3, lying free in the installation position and facing away from the underside 2.

From its underside 2, a cut-out 4 is formed into the guide plate 1, the opening 5 of which accommodates by far the largest part of the underside 2. Here, the cut-out 4 is defined by a first longitudinal side wall 6 facing the rail which is to be installed, a rearward second longitudinal side wall 7 arranged opposite this, a first narrow side wall 8 extending at the one narrow side of the guide plate 1, and a second narrow side wall 9 arranged opposite this, facing the other narrow side of the guide plate 1.

The surfaces of the longitudinal sides 6, 7 and the narrow sides 8, 9, facing the underside 2, form a mounting surface 10, with which the guide plate 1 in the installation position stands on the respective substrate. In the corner areas between the first longitudinal side 6 and the narrow side walls 8, 9 in this situation a corner step 11, 12 is formed, projecting in the direction of the cut-out 4 in each case, so that an extended area of the mounting surfaces 10 is provided at that point. At the same time, the wall thickness of the second longitudinal side 7 is greater than that of the first longitudinal side 6, so that secure support of the guide plate is also guaranteed in the area of the second longitudinal side 7.

The first longitudinal side 6 faces the foot 13 of the rail 14 which is to be installed. On its side facing the foot of the rail 13, a flat contact surface 15 is also formed, which extends over the width B of the guide plate 1 and with the mounting surface 10 encloses a right angle. In the installation position the rail foot 13 is supported on the contact surface 15.

A channel 16, 17 is formed into the narrow side walls 8, 9 in each case, which leads from the cut-out 4 to the surrounding area U, and is designed in the form of cut-outs open towards the mounting surface 10. In exactly the same way, channels 18, 19, 20 are formed into the second longitudinal wall 7, arranged at regular distance intervals from one another, by means of which the fluid (rain water) can also flow away when the guide plate is in the installation position.

A passage aperture 22 is formed at a central position into the roof section 21 of the guide plate 1, which leads from the upper side 3 of the guide plate 1 into the cut-out 4. The passage aperture 22 in this situation has the shape of an extended groove, the longitudinal axis of which is aligned transversely to the contact surface 15.

Two reinforcement ribs 23, 24 are present in the cut-out 4, in each case aligned transversely to the contact surface 15, which start from the roof surface 25 formed by the underside of the roof section 21 of the guide plate 1 and extend in each case between the longitudinal side walls 6, 7 of the guide plate 1. The one reinforcement rib 23 in this situation is arranged in close proximity to the one longitudinal side of the passage aperture 22, while the other reinforcement rib 24 is positioned closely adjacent to the other longitudinal side of the passage aperture 22.

The reinforcement ribs 23, 24 have in each case a section 23a, 24a connected to the rear longitudinal wall 7, which extends nearly over the entire height H of the cut-out 4. However, it ends with a small distance interval H1 to the mounting surface 10, such that the reinforcement ribs 23, 24 in this area also do not come into contact with the substrate on which the guide plate 1 stands when in practical use.

Starting from the longitudinal wall 7, the individual section 23a, 24a of the reinforcement ribs 23, 24 extends over approximately one third of the depth T of the cut-out 4 and there merges into a second section 23b, 24b, which has a perceptibly lesser height H2 than in the area of its individual section 23a, 24a. The narrow side 23c, 24c of the section 23a, 24a leading to the second section 23b, 24b is in this case aligned at a right angle to the mounting surface 10 and parallel to the contact surface 15.

The individual section 23b, 24b extends in each case as far as the longitudinal side wall 6. In this way, inside cut-out 4 a free spatial volume is delimited between the longitudinal side wall 6, the narrow sides 23c, 24c of the sections 23a, 24a facing it and the narrow side walls 8, 9, the shape and outer dimensions of which are designed with a specific over-dimension in such a way that a shoulder 26 present on the firm substrate U, on which the rail 14 is to be secured, can be securely accommodated in this free volume with optimum alignment of this shoulder 26. The height H2 of the sections 23b, 24b of the reinforcement ribs 23, 24 is in this case dimensioned in such a way that, when the guide plate 1 is not under load, the underside 23d, 24d of the sections 23b, 24b and the side surface 23c, 24c of the sections 23a, 24a are arranged at a small distance interval above and to the side respectively of the shoulder 26.

Due to the fact that also the volume of the cut-out 4 present between the sections 23a, 24a and between the respective narrow side wall 8, 9 and the section 23a, 24a of the reinforcement ribs 23, 24 facing it is confined, the guide plate 1 has a minimized mass and a correspondingly minimized weight.

Formed on the free upper side 3 of the guide plate 1, adjacent to the edge facing the rear longitudinal side wall 7 are two grooves 28, 29 from which the one emerges from the side of the guide plate 1 facing the narrow side wall 8 and the other emerges from the side facing the narrow side wall 9. The grooves 28, 29 are separated by a reinforcement rib 30 which is aligned in the middle and transversely in relation to the contact surface 15.

In addition, two guide ribs 31, 32 are present on the upper side 3 of the guide plate 1, of which the one extends parallel to the one longitudinal side and the other extends parallel to the other longitudinal side of the passage aperture 22. The guide ribs 31, 32 are supported by support sections 33, 34 extending parallel to the contact surface 15 on their sides facing the narrow side wall 8 and narrow side wall 9 respectively, while their side surfaces facing the passage aperture 22 merge in each case in a neck into the surface surrounding the passage aperture 22. In the installed state, the guide ribs 31, 32 support the middle loop 35 of a w-shaped spring element 36, which with its spring arms 37, 38 exerts in a known manner the spring forces required to hold down the rail 14.

The transition area 39 between the upper side 3 and the contact surface 15 of the guide plate 1 is designed as rounded. In this situation, two connection webs 40, 41 arranged at a distance from one another, are formed at the transition area 39. At their end facing away from the transition area 39, the connection webs 40, 41 carry an insulator element 42, which extends parallel to the contact surface 15. Formed into its free upper side are two grooves 43, 44, likewise extending parallel to the contact surface 15, which in each case emerge from the facing narrow sides of the insulator element 42 and are separated from one another by a web arranged in the middle.

The grooves 43, 44 of the insulator element 42 form mountings, in which sit, when the guide plate 1 is installed, the cropped end sections 45, 46 of the spring arms 37, 38 of the individual spring element 36.

The connection webs 40, 41 are designed, according to the type of predetermined break points, in such a way that they automatically break through when the force exerted on them by the spring arms 37, 38 exceeds a specific value. In this way, the insulator element 42 is automatically separated from the guide plate 1 in the course of installation.

A system S formed by making use of a guide plate 1 in each case for securing the rail 14 onto a substrate U, formed here, for example, by a sleeper made of cast concrete, comprises, in addition to the guide plate 1 and the spring element 36, a shoulder piece 47 and a tensioning element 48. In each case, two systems S are needed to secure the rail 14, wherein the one system S is arranged on the one side of the rail 14 and the other system S is arranged on the opposite side.

The shoulder 26 is formed by the section of the shoulder piece 47, with which the shoulder piece 47 projects freely over the surface of the substrate U, while it is cast indissolubly into the substrate U with a tongue-like, s-shaped curved securing section 49. The shoulder 26 in this situation has a mounting 50, which extends on the rear longitudinal side wall 7 of the guide plate 1, facing away from the rail 14, parallel to the surface of the substrate U. In addition, a cut-out, not visible here, is formed into the upper section of the shoulder 26, delimiting the mounting 50 on its upper side, starting from the edge facing the longitudinal side wall 7, arranged in a middle position in relation to the mounting 50.

The tensioning element 48, having the basic form of a screw bolt, has a shaft section 51 provided with an outer thread and a coupling section 52 formed onto this, which is formed by two flat areas, which project opposite one another laterally from the shaft section 51 at one end of the shaft section 51. The thickness of the areas concerned is dimensioned in this case in such a way that the coupling section 52 can be introduced with a small amount of play into the mounting 50 of the shoulder 26.

In order to provide protection against abrasive wear, an abrasion plate 53 is applied to the substrate U. An intermediate layer 54 of elastic material additionally lies on the abrasion plate 53. The rail 14 sits in turn on the intermediate layer 54, such that it has a defined degree of flexibility in the direction of the substrate U.

To assemble the system S, the tensioning element 48 is introduced with its coupling section 52 into the mounting 50 in such a way that the shaft section 51 of the tensioning element 48 faces away from the substrate U and sits in that cut-out which is formed into the section of the shoulder 26 which delimits the mounting 50 on its upper side.

The guide plate 1 is then placed onto the substrate U, wherein the shaft section 51 of the tensioning element 48 is guided through the passage aperture 22. The guide plate 1 is positioned in this situation in such a way that the shoulder 26 sits in the cut-out 4 of the guide plate 1. The contact surface 15 of the guide plate 1 is then located to the side of the foot 13 of the rail 14.

With the shoulder 26 optimally aligned, the guide plate 1 now already sits on the substrate U, without there being direct contact between the shoulder and the reinforcement ribs 23, 24 of the guide plate 1. However, because such optimum conditions are the exception in practice, it may occur that the guide plate 1, after placement, sits with at least a part of its reinforcement ribs 23, 24 on the shoulder 26 or in contact with it. In this situation, the guide plate 1 still does not, as a rule, sit properly on the substrate U.

After the placing the guide plate 1, the insulator element 42 is positioned above the rail foot 13.

The spring element 36 is now aligned on the guide plate 1 in such a way that its middle loop 35 is guided between the guide ribs 31, 32 of the guide plate 1 and the curved transition areas between the middle loop 35 and the individual spring arm 37, 38 of the spring element 36 sit in each case in one of the grooves 28, 29. At the same time, the cropped end sections 45, 46 of the spring arms 37, 38 sit in the groove 43, 44 of the insulator element 42 facing them in each case.

Finally, a nut 55 is screwed onto the shaft section 51 of the tensioning element 48, until this sits on the middle loop 35 of the spring element 36 surrounding the shaft section 51 laterally. The nut 55 is then further tightened until the spring element 36 is tensioned sufficiently for it to exert the forces onto the rail foot 13 required to hold down the rail 14. The guide ribs 31, 32 in this situation prevent the middle loop 35 from becoming twisted.

In the course of this tensioning process, the roof section 21 of the guide plate 1 sinks as necessary until the reinforcement ribs 23, 24 rest on the shoulder 26.

In cases in which the guide plate 1, due to imprecise positioning of the shoulder 26, has not in the first instance settled firmly on the substrate, the reinforcement ribs 23, 24 will now break, as appropriate, such that the free space present in the cut-out 4 for accommodating the shoulder 26 automatically expands sufficiently for the shoulder 26 to be accommodated entirely by the cut-out 4 and the guide plate 1 sits with its mounting surface 10 on the substrate U.

In the course of the tensioning process the connection webs 40, 41 also break, such that the insulator element 42 sits freely movable on the rail foot 13 and the forces exerted by the spring arms 37, 38 are transferred unhindered onto the rail 14.

### REFERENCE SYMBOLS

1 Guide plate
2 Underside of the guide plate 1
3 Upper side of the guide plate 1
4 Cut-out of the guide plate 1
5 Opening of the cut-out 4
6,7 Longitudinal side walls of the guide plate 1
8,9 Narrow side walls of the guide plate 1
10 Mounting surface of the guide plate 1
11,12 Corner steps
13 Rail foot of the rail 14
14 Rail
15 Contact surface
16-20 Channels
21 Roof section
22 Passage aperture
23,24 Reinforcement ribs
23a,24a First sections of the reinforcement ribs 23, 24
23b,24b Second sections of the reinforcement ribs 23, 24
23c,24c Free narrow sides of the sections 23a, 24a
25 Roof surface of the cut-out 4
26 Shoulder
23d,24d Underside of the sections 23b, 24b
28,29 Grooves
30 Reinforcement rib
31,32 Guide ribs
33,34 Support sections
35 Middle loop of the spring element 36
36 w-shaped spring element
37,38 Spring arms
39 Transition area
40,41 Connection webs
42 Insulator element
43,44 Grooves
45,46 End sections of the spring arms 37, 38
47 Shoulder section
48 Tensioning element
49 Securing section
50 Mounting
51 Shaft section of the tensioning element 48
52 Coupling section
53 Abrasion plate
54 Elastic intermediate layer
55 Nut

### REFERENCE SYMBOLS

B Width of the guide plate 1
H Height of the cut-out 4
H1 Distance interval
H2 Height of the second sections 23b, 24b
S System for securing the rail 14
U Substrate

What is claimed is:

1. Guide plate for a system for securing a rail on a substrate, at which a shoulder is present at a side of a rail path, which absorbs the forces arising when a rail vehicle travels over the rail, the guide plate comprising an underside facing the substrate and an upper side, lying freely in an installation position and facing away from the underside, on which a spring element can be supported, which is provided for the applying of spring elastic hold-down forces onto the rail which is to be secured, wherein a cut-out is formed into the underside of the guide plate, the dimensions of which are adapted to the dimensions of the shoulder in such a way that, in the installation position of the guide plate, the shoulder engages freely into the cut-out, and in that at least one reinforcement rib is formed at a roof surface of the cut-out opposite an opening of the cut-out, which projects in the direction of the opening of the cut-out over a height which is less than the height of the cut-out.

2. Guide plate according to claim 1, wherein the guide plate has on a face side, facing the rail which is to be secured, a flat contact surface for the rail foot.

3. Guide plate according to claim 2, wherein the at least one reinforcement rib is aligned transverse to the contact surface.

4. Guide plate according to claim 1, wherein the cut-out formed in the underside on a front side facing the rail and a rear side opposite the front side, and the sides extending between the front and rear side, is in each case delimited by a wall of the guide plate.

5. Guide plate according to claim 4, wherein at least one channel is provided in at least one of the walls leading from the cut-out to an outside surface, for conducting away fluid which has collected in the cut-out.

6. Guide plate according to claim 5, wherein the at least one channel is open in a direction of the underside of the guide plate.

7. Guide plate according claim 1, wherein the guide plate has a passage aperture leading from the upper side into the cut-out, through which, during installation, a tensioning element can be inserted in order to tension the spring element.

8. Guide plate according to claim 7, wherein in each case a reinforcement rib is arranged inside the cut-out to a side of the passage aperture.

9. Guide plate according to claim 1, wherein the guide plate is manufactured as one piece from a plastic material.

10. Guide plate according to claim 9, wherein the plastic material is fiber-reinforced.

11. Guide plate according to claim 1, wherein shaped elements are provided on the upper side for at least section by section lateral guidance of the spring element supported on the guide plate.

12. Guide plate according to claim 1, wherein the upper side has at least one reinforcement rib.

13. Guide plate according to claim 1, wherein the guide plate carries an insulator element on a face side facing the rail which is to be secured, extending parallel to the face side, which during installation is intended to be mounted on the foot of the rail which is to be secured in such a way that the spring element applying the hold-down force takes effect on the rail by way of the insulator element.

14. Guide plate according to claim 13, wherein the insulator element is formed as one piece at the guide plate and a predetermined break point is formed in a transition area between the insulator element and the guide plate.

15. Guide plate according to claim 13, wherein the insulator element is formed such as to be plugged to the guide plate.

16. System for securing a rail on a substrate, at which a shoulder is present at the side of the rail path, comprising a spring element for exerting an elastic hold-down force onto the rail, a guide plate for guiding the spring element, and a tensioning element for tensioning the spring element against the substrate wherein, the guide plate is formed according to claim 1.

17. System according to claim 16, wherein the tensioning element has a coupling section for positive fit coupling to the shoulder provided at the substrate.

18. System according claim 16, wherein the system further comprises an elastic intermediate layer.

19. System according to claim 18, wherein, in a finished installed system, the intermediate layer extends beneath the rail which is to be secured.

20. System according to claim 16, wherein the system further comprises an abrasion plate which, in a finished installed system, lies on the substrate.

21. System according to claim 16, wherein the system further comprises a sleeper forming the substrate.

22. System according to claim 21, wherein the sleeper is cast from concrete or is made of wood, steel, or plastic.

23. System according to claim 16, wherein the shoulder of the substrate is formed by a cast part, which sits with a securing section securely in the substrate.

24. System according to claim 16, wherein a guide plate is allocated to each longitudinal side of the rail.

25. System according to claim 24, wherein the guide plates are connected to one another as one piece by a section which in the installation position extends under the rail.

26. System according to claim 16, wherein a plate is provided resting on the substrate, at which the shoulder is formed and on which, in a finished installed state, the guide plate sits.
